(19) United States
(12) Patent Application Publication
(10) Pub. No.: US 2011/0006916 A1
(43) Pub. Date: Jan. 13, 2011

(54) Assistance in Parking a Vehicle Between Front and Rear Objects

(76) Inventor: Salvador Toledo, Ypsilanti, MI (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 12/498,558

(22) Filed: Jul. 7, 2009

(51) Int. Cl. G08G 1/14

(52) U.S. Cl. 340/932.2

(57) ABSTRACT

A method for assisting in parking a vehicle in a parking space between front and rear objects includes determining a length of the parking space and the location of the vehicle relative to the parking space from signals produced by sensors located on the vehicle, determining a first distance between a rear surface of the vehicle and the rear object from a signal produced by a distance sensor on the vehicle directed rearward toward the rear object or the vehicle location estimation relative to the rear object, determining a second distance between a front surface of the vehicle and the front object from the current first distance and the length of the parking space or the vehicle location estimation relative to the front object, and warning the vehicle operator to change between forward and reverse drive when the first and second distances become equal to or less than a reference distance from a respective one of the objects.

### BACKGROUND OF THE INVENTION

1. Field of the Invention

This invention relates generally to assisting a vehicle operator in parallel parking a vehicle in a space between front and rear objects.

2. Description of the Prior Art

Various systems and techniques are available to prompt a vehicle operator to stop a vehicle and reverse its direction in order to avoid striking objects located at the front and rear of the vehicle while parallel parking between the objects. Such systems include a sensor located at the front of the vehicle, which produces signals representing distance between the vehicle's frontmost surface and the object at the front of the vehicle, and a sensor located at the rear of the vehicle, which produces signals representing distance between the vehicle's rearmost surface and the object at the rear of the vehicle.

A need exists for a technique that can estimate with acceptable accuracy the distance between the vehicle's frontmost surface and the object at the front of the vehicle without use of a front sensor, electrical communication data bus and wiring connecting the front sensors, a computer and signaling devices.

### SUMMARY OF THE INVENTION

A method for assisting in parking a vehicle in a parking space between front and rear objects includes determining a length of the parking space and a location of the vehicle relative to the parking space from signals produced by sensors located on the vehicle, determining a first distance between a rear surface of the vehicle and the rear object from a signal produced by a distance sensor on the vehicle directed rearward toward the rear object, determining a second distance between a front surface of the vehicle and the front object from the current first distance and the length of the parking space, and warning the vehicle operator to change between forward and reverse drive when the first and second distances become equal to or less than a reference distance from a respective one of the objects.

The method provides the front object distance continually during a parking maneuver without using front park aid hardware, such as distance sensors.

This eliminates the need for front park distance sensors, bezels, wiring harness and unique front fascia hard tool and sonic welder that would otherwise be required to produce front park sensor holes.

Consequently the method reduces the cost and complexity of the park assist system and associated tooling, yet it provides a reliable park assist function.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

The invention will be more readily understood by reference to the following description, taken with the accompanying drawings, in which:

FIG. 1 is a top view of a vehicle showing various sensors used to assist the operator in parking the vehicle;

FIG. 2 is a top view showing a vehicle being parallel parked between two objects; and

FIG. 3 is a top view showing the vehicle being parallel parked between the objects at a later time than as shown in FIG. 2.

### DESCRIPTION OF THE PREFERRED EMBODIMENT

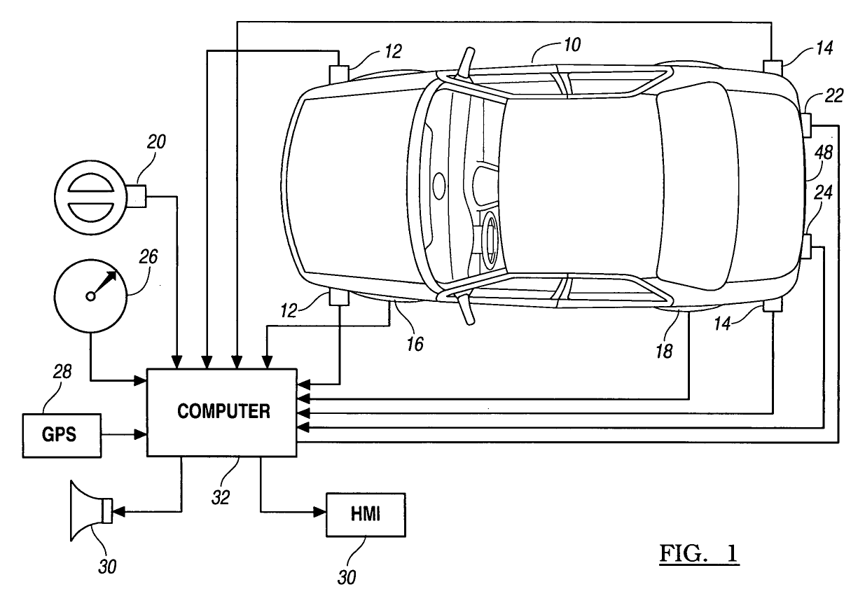

Referring now to the drawings, there is illustrated in FIG. 1 a vehicle 10 equipped with at least one distance sensor 12, 14, preferably located in the front fascia or rear fascia, respectively, and directed laterally from a longitudinal axis of the vehicle; front and rear wheel odometric sensors 16, 18; steering wheel angle sensor 20; optional rear park aid distance sensors 22, 24 directed rearward preferably from a rearmost surface of the vehicle; yaw angle sensor 26; access to data from a global positioning system 28; an onboard warning device 30, such as a graphical human machine interface (HMI), audible chimes, buzzer, siren or a combination of these; and an onboard electronic computer 32, which communicates with the sensors and output devices.

The computer 32 is accessible to electronic memory containing an algorithm that processes signals produced by the sensors. The algorithm contains method steps processed by the computer and written in computer-readable coded format for guiding the vehicle operator in parking the vehicle 10.

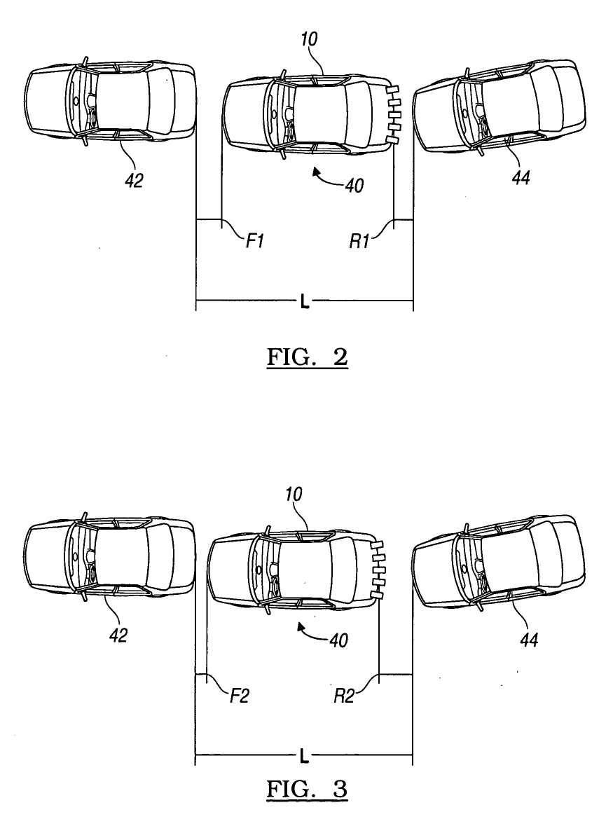

As FIG. 2 illustrates, the vehicle 10 is first driven alongside a parking space 40 between a front object 42 and rear object 44. Signals produced by the side sensors 12, 14, steering wheel angle sensor 20 and wheel odometric sensors 16, 18 are transmitted to the computer 32 and converted using the algorithm to the length L of the parking space 40 and the location of vehicle 10 relative to the parking space.

Referring to FIG. 3, when the vehicle operator starts the parking maneuver by steering the vehicle into the parking space 40, the algorithm continues to estimate the location of the vehicle 10 relative to the front and rear objects 42, 44.

The algorithm determines the estimated distance R1 between the rearmost surface 48 of vehicle 10 and rear object 44 from data produced by front wheel odometric sensors 16, 18, steering wheel angle sensor 20, and the estimated location of the vehicle 10 relative to the front and rear objects 42, 44. The optional rear park aid ultrasonic sensors 22, 24 can confirm the estimated R1 distance, but they are not necessary. The algorithm calculates an estimated distance F1 between the frontmost surface 46 of vehicle 10 and front object 42 using the relationship

F1=L−R1 (1)

In case that the rear object 44 is not present, the algorithm calculates the F1 distance based on the estimated location of the vehicle 10 relative to the front object 42. Later during the parking maneuver, the distance R2 is calculated with reference to the current, reliable R1 value and the change in the vehicle position resulting from moving the vehicle forward from the position of FIG. 2 to that of FIG. 3. This change in vehicle position is determined from data provided by signals produced by the wheel odometric sensors 16, 18 and steering wheel angle sensor 20.

Distances F and R are repetitively updated with reference to data produced by wheel odometric sensors 16, 18, the optional rear park aid ultrasonic sensors 22, 24 and the steering wheel angle sensor 20, as the vehicle moves.

At all times during the parking maneuver, the estimated distance F1, F2 is used to prompt the driver to stop the vehicle 10 and reverse its direction when the estimated distance is equal to or less than a reference distance from the front object 42. Similarly, the estimated distance R1, R1 is used to prompt the driver to stop the vehicle 10 and drive in a forward direction when the estimated distance R1 is equal to or less than a reference distance from the rear object 44. The prompts that advise the operator driver of the proximity to the objects 42, 44 are preferably audible or visual, or a combination of audible and visual, such as is provided by a graphical HMI.

When the optional rear park aid sensors 22, 24 detect the rear object 44, this reconfirms the vehicle location relative to the front and rear objects 42, 44. The reconfirmation is not necessary, but it provides more accuracy to the estimation of the distance to the front object 42.

The steering wheel angle sensor 20 may be an absolute steering wheel angle sensor or a relative angle sensor, which would decrease accuracy of the estimates distance F1.

The side sensors 12, 14 and the rear park aid sensors 22, 24 may be ultrasonic, radar, thermal, Lidar, camera, or laser sensors.

Data produced by a global positioning system (GPS) can be used as an alternative to data from the wheel odometric sensors 16, 18.

In accordance with the provisions of the patent statutes, the preferred embodiment has been described. However, it should be noted that the alternate embodiments can be practiced otherwise than as specifically illustrated and described.

The invention claimed is:

1. A method for assisting in parking a vehicle in a parking space between front and rear objects, comprising the steps of:
(a) determining a length of the parking space and a location of the vehicle relative to the parking space from signals produced by a distance sensor directed laterally toward the parking space, a steering wheel angle sensor and a wheel odometric sensor located on the vehicle;
(b) repetitively determining a first distance between a rear surface of the vehicle and the rear object from one of the vehicle location estimation relative to the rear object or and a signal produced by a distance sensor on the vehicle directed rearward toward the rear object;
(c) repetitively determining a second distance between a front surface of the vehicle and the front object from one of the vehicle location estimation relative to the front object and the current first distance and the length of the parking space; and
d) repetitively warning a vehicle operator while parking the vehicle to change between forward and reverse drive when the first and second distances become equal to or less than a reference distance from a respective one of the front and rear objects.

2. The method of claim 1, wherein step (c) further comprises:
determining the second distance from the relationship F=L−R, wherein F is the second distance, L is the length of the parking space, and R is the first distance.

3. The method of claim 1, wherein step (b) further comprises:
determining a next first distance from the first distance minus a calculated distance the vehicle has moved toward the rear object since determining the first distance.

4. The method of claim 1, wherein step (b) further comprises:
using a distance sensor on the vehicle directed rearward toward the rear object that is one of ultrasonic, radar, thermal, Lidar, camera, and laser.

5. The method of claim 1, wherein step (b) further comprises:
estimating the distance based on the vehicle location estimation relative to the rear object.

6. The method of claim 1, wherein step (a) further comprises:
using one of an absolute steering wheel angle sensor, a relative steering wheel angle sensor, and a yaw angle sensor.

7. The method of claim 1, wherein step (a) further comprises:
using a distance sensor directed laterally toward the parking space that is one of ultrasonic, radar, thermal, Lidar, camera and laser.

8. The method of claim 1, wherein step (a) further comprises using data produced by a global positioning system.

9. A method for assisting in parking a vehicle in a parking space between front and rear objects, comprising the steps of:
(a) determining a length of the parking space and a location of the vehicle relative to the objects using signals produced by a distance sensor directed laterally toward the parking space, steering wheel angle sensor, and a wheel odometric sensor located on the vehicle;
(b) determining a first distance between a rear surface of the vehicle and the rear object from one of a signal produced by a distance sensor on the vehicle directed toward the rear object, and by estimating the first distance based on the vehicle location estimation relative to the rear object;
(c) determining a second distance between a front surface of the vehicle and the front object using one of the current first distance and the length of the parking space and the vehicle location estimation relative to the front object; and
(d) warning a vehicle operator while parking the vehicle to change between forward and reverse drive when the first and second distances become equal to or less than a reference distance from a respective one of the front and rear objects;
(e) determining a next first distance from said first distance minus a calculated distance through which the vehicle has moved toward the rear object since determining the first distance.

10. The method of claim 9, wherein step (c) further comprises:
determining the second distance from the relationship F=L−R, wherein F is the second distance, L is the length of the parking space, and R is the first distance.

11. The method of claim 9, wherein step (b) further comprises:
using a distance sensor on the vehicle directed rearward toward the rear object that is one of ultrasonic, radar, thermal, Lidar, camera and laser.

12. The method of claim 9, wherein step (a) further comprises:
using one of an absolute steering wheel angle sensor, a relative steering wheel angle sensor, and a yaw angle sensor.

13. The method of claim 9, wherein step (a) further comprises:
using a distance sensor directed laterally toward the parking space that is one of ultrasonic, radar, thermal, Lidar, camera and laser.

14. The method of claim 9, wherein step (a) further comprises:
using data produced by a global positioning system rather than that wheel odometric sensor and a steering wheel angle sensor.
